(19) United States
(12) Patent Application Publication
(10) Pub. No.: US 2007/0271404 A1
(43) Pub. Date: Nov. 22, 2007

(54) Realtime multithreaded hot-plug control

(75) Inventors: Glenn A. Dearth, Groton, MA (US); Stephen A. Jay, Chelmsford, MA (US); Joseph J. Ervin, Stow, MA (US); Gyorgy Rubin, Burlington, MA (US); Michael V. Lopresti, Husdon, MA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/435,234

(22) Filed: May 16, 2006

(51) Int. Cl. G06F 9/46; G06F 13/00

(52) U.S. Cl. 710/302; 718/100

(57) ABSTRACT

A method for controlling hot-plug behavior includes identifying a hot-plug event caused by a hot-plug device; generating hot-plug threads that execute a hot-plug operation; executing a finite state machine state sequence to regulate hot-plug threads involved in the hot-plug operation; and completing the hot-plug operation at the end of the finite state machine state sequence. A computer usable medium has computer readable program code embodied therein for causing a computer system to execute the method for controlling hot-plug behavior. A hot-plug control system for a computer system includes a hot-plug device; a set of hot-plug threads that regulate operations in the hot-plug device; and a finite state machine that controls execution of instructions using the set of threads.

### BACKGROUND

Hot-plug, also known as hot-swapping, refers to the ability to add and remove components from a computer system while the main power is on and have the operating system recognize the change. Hot-plug allows components to be inserted and removed without rebooting the system. Protocols that support hot-plug include PCMCIA, USB, FireWire, Fibre Channel, and SATA. Hot-plug components include USB drives, server hard drives, PCI-X or PCI Express expansion cards, PCMCIA cards, and some power supplies.

Hot-plug support from a system perspective requires a number of hardware and software mechanisms to be developed. First, the system needs to be able to detect when a component is inserted or removed. In addition, all electrical and mechanical connections must be designed such that neither the component or the user will be harmed by inserting or removing it. Other components in the system must also be designed such that a hot-plug event does not harm their operation.

Simple hot-plug implementations usually require a shut down procedure to be performed prior to removal. Often such devices are not robust when the component fails, and these types of hot-plug operations are reserved for moving peripheral devices from one system to another, or for synchronizing data between a device and a computer. More complex hot-plug implementations usually contain enough redundancy such that even if a shut down procedure is recommended, operation would continue if a device were removed without executing the shut-down procedure. Hot-plug operations of these types are used for regular system maintenance or broken component replacement.

A typical hot-plug implementation uses a sequential tree structure and a producer/consumer model for regulating threads. Once a hot-plug event is triggered, threads descend down the branches, timed carefully to synchronize sharing of resources (i.e. producer thread writes shared data, consumer thread reads it). These threads may execute “clean up” actions to prepare the component and OS for the hot-plug event. Nodes of the tree correspond to wait or sleep states, and code is executed in between. There are several drawbacks to this method. First, each thread must descend all the way to the bottom of the tree before it is allowed to exit, thus limiting the allowable options in contingency situations. In addition, the code quickly becomes spaghetti-like and desynchronized as additions and revisions are made. For example, if a particular branch corresponding to writing of a shared resource needs to be delayed to fix a problem, doing so may cause another thread trying to read the shared resource to access the data block before it is written to. Fixing the second thread may cause further problems, and so on, causing a compounding effect in the number of new bugs created in the debugging process.

Hot-plug is especially useful for Enterprise-class servers, which are rated based on their uptime. It allows components to be removed without taking down the system. Without hot-plug, the server would need to be rebooted after a major component was installed or removed. This is both time consuming and costly, as servers are rated by their uptime. A reboot would take down the server for a period of time, as well as affect the overall performance of the network during that period.

### SUMMARY

In accordance with one or more embodiments of the present invention, a method for controlling hot-plug behavior comprises identifying a hot-plug event caused by a hot-plug device; generating hot-plug threads that execute a hot-plug operation; executing a finite state machine state sequence to regulate hot-plug threads involved in the hot-plug operation; and completing the hot-plug operation at the end of the finite state machine state sequence.

In accordance with one or more embodiments of the present invention, a computer usable medium having computer readable program code embodied therein for causing a computer system to execute a method for controlling hot-plug behavior comprises identifying a hot-plug event caused by a hot-plug device; generating hot-plug threads that execute a hot-plug operation; executing a finite state machine state sequence to regulate hot-plug threads involved in the hot-plug operation; and completing the hot-plug operation at the end of the finite state machine state sequence.

In accordance with one or more embodiments of the present invention, a hot-plug control system for a computer system comprises a hot-plug device; a set of hot-plug threads that regulate operations in the hot-plug device; and a finite state machine that controls execution of instructions using the set of threads.

Other aspects and advantages of the invention will be apparent from the following description and the appended claims.

### BRIEF DESCRIPTION OF DRAWINGS

FIG. 1 shows a schematic diagram of a system in accordance with one or more embodiments of the invention.

FIG. 2 shows a schematic diagram of a finite state machine employing state sharing between threads in accordance with one or more embodiments of the invention.

FIG. 3 shows a flow diagram of a hot-plug remove operation in accordance with one or more embodiments of the invention.

FIG. 4 shows a flow diagram of a thread operating within a finite state machine in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus to manage hot-plug operations with a finite state machine. Specifically, embodiments of the invention provide a method and apparatus for managing sophisticated hot-plug thread operations using a state-sharing sequence control engine and testing compliance of hot-plug mechanisms using a fault injection mechanism. Unlike the traditional tree-structure used in typical hot-plug controllers, embodiments of the invention regulate hot-plug threads by setting wake and sleep periods for each thread. A thread is allowed to perform operations if upon waking, it has ownership of the current state. Once a thread has finished operations, the state is updated and the thread goes back to sleep. This prevents spaghetti-like code and desynchronization, allows process termination once a thread goes to sleep, and provides a more extensible and bug-free environment for development and debugging.

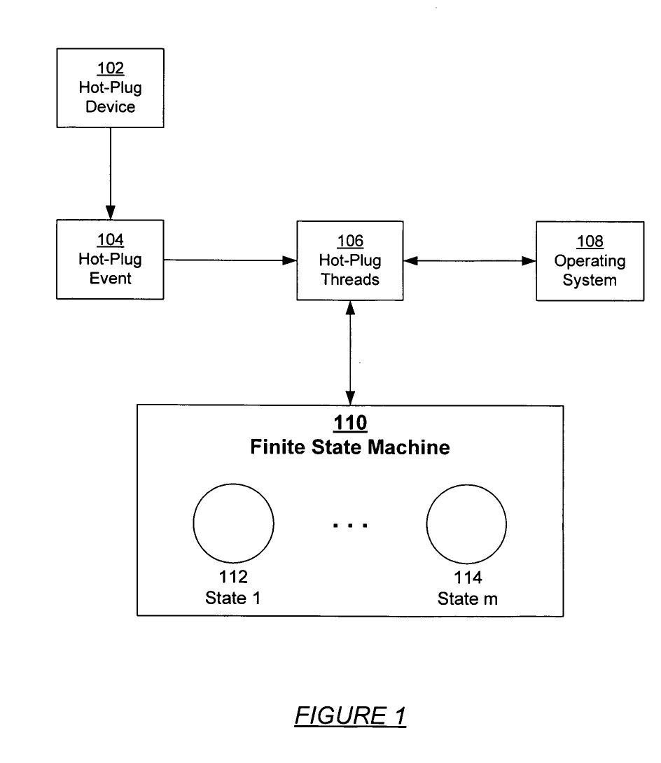

FIG. 1 shows a schematic diagram of a hot-plug control system in accordance with one or more embodiments of the invention. As shown in FIG. 1, the system includes a hot-plug device (102), which generates a hot-plug event (104). The hot-plug event (104) causes one or more hot-plug threads (106) to execute, which are then controlled by the finite state machine (110). The hot-plug threads (106) must also communicate with the operating system (108), notifying it of a hot-plug request, and perform clean-up operations so the hot-plug device (102) can be properly removed. In one or more embodiments of the invention, a hot-plug event (104) may be triggered from the operating system (108) instead of from the hot-plug device (102). For example, a user may use a hardware manager on the operating system (108) to begin the hot-plug process instead of pressing a button on the hot-plug device (102).

A hot-plug device (102) may consist of any type of removable hardware that is not vital to the core functionality of the operating system (108). For example, a hot-plug device (102) may be a PCI card, a hard drive, a PCMCIA card, or other types of printed circuit boards. A hot-plug event (104) refers to insertion or removal of a hot-plug device (102) and may be initiated by various means. For example, a hot-plug event may be triggered by notifying the operating system (108) that a hot-plug device (102) is to be inserted or removed, or by manually pressing a button on the hot-plug device (102) or simply inserting or removing the hot-plug device (102) itself.

Once the hot-plug event (104) is triggered, it spawns one or more hot-plug threads (106) to handle the hot-plug event (104). In one or more embodiments of the invention, a hot-plug event (104) involves more than just removal or addition of power to the hot-plug device (102). For example, if the operating system (108) is using the hot-plug device (102) and a remove operation is triggered, clean-up operations must be performed to save relevant data, prevent system errors, and properly shut down the hot-plug device (102) before it can be physically removed. Furthermore, in one or more embodiments of the invention, a hot-plug event (104) may refer to a surprise insertion or removal of a hot-plug device (102) before the system is adequately prepared. In such cases, the system should be robust enough such that the hot-plug threads (106) and the finite state machine (110) would handle the surprise hot-plug event (104) without causing a fatal error and shutting down the operating system (108).

As shown in FIG. 1, the system also contains a finite state machine (110) to control operations by the hot-plug threads (106). The finite state machine (110) contains multiple states (state 1 (112), state m (114)) which regulate the hot-plug threads (106). Those skilled in the art will appreciate that the finite state machine (110) may have an arbitrary number of states (state 1 (112), state m (114)), including cases where there are no states, one state, in which state 1 (112) and state m (114) correspond to the same state, or multiple states, wherein state 1 (112) and state m (114) correspond to distinct states. Those skilled in the art will also appreciate that an arbitrary number of states may be used to implement the same functionality in a finite state machine (110).

The fault injection mechanism (116) is used to validate the control logic of the hot-plug control system. It is used to determine the system's general state as well as to insert faults into the hot-plug control system. For example, a forced eject fault may be placed into the hot-plug control system to test its response and ensure that crashes are avoided and the fault is handled in a robust manner. After the fault is inserted, control flows of all hot-plug threads (106) can be traced to determine if the hot-plug control system is handling the fault appropriately. Because the present invention significantly reduces the complexity of producer/consumer thread interaction and the associated state space, tracing the control flows of hot-plug threads (106) for validation of real-time control logic is simplified as well.

The fault injection mechanism (116) may be implemented using a set of registers connected to a microcontroller or processor, which will allow it to assess the general state of the hot-plug control system. While some registers may be read-only, the fault injection mechanism may be introduced to the hot-plug control system using two registers. One register may be used to enable or disable fault insertion, which may help prevent inadvertent insertion of faults into the system. For example, if the enable/disable register were set to an “enable key” value, fault injection would be enabled, and if the register were set to any other value, fault injection would be disabled. The second register may contain addressing bits, which direct the fault to a specific location on the hot-plug device, and fault bits, which can be used to apply a set of defined fault types to the hot-plug device. Those skilled in the art will appreciate that the fault injection mechanism (116) may be implemented using other methods.

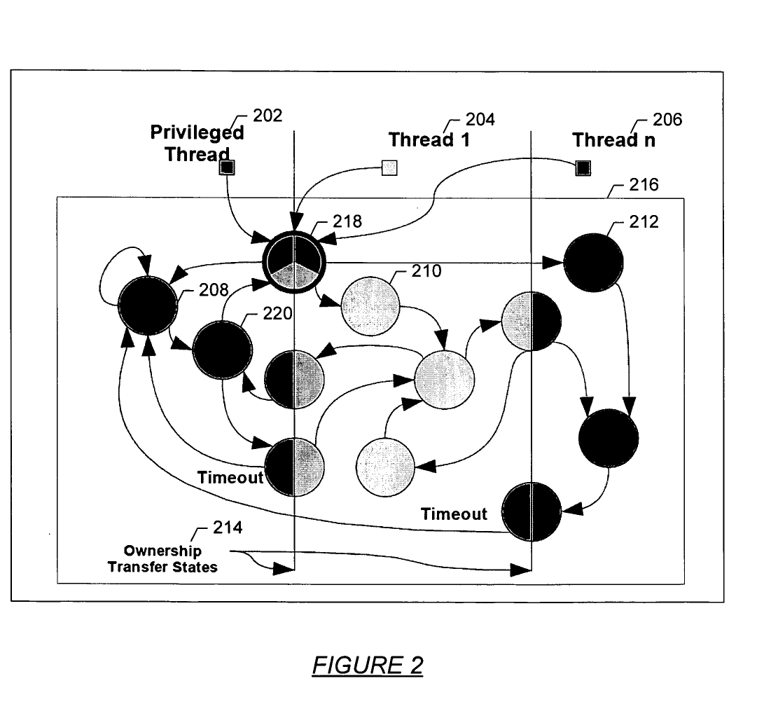

FIG. 2 shows a schematic diagram of a finite state machine employing state sharing between threads in accordance with one or more embodiments of the invention. Unlike typical producer-consumer models, where sharing of resources must be synchronized carefully between threads, the finite state machine inherently contains restrictions that enforce mutual exclusion of threads from critical sections. In other words, no two threads are allowed to access shared resources at the same time, thus preventing timing and access issues associated with conventional hot-plug implementations.

As shown in FIG. 2, the finite state machine contains a set of threads (privileged thread (202), thread 1 (204), thread n (206)) and a set of states (216). In one or more embodiments of the invention, the privileged thread (202) is the thread that currently has control and is allowed to execute. Those skilled in the art will appreciate that once another thread assumes control, it becomes the privileged thread (202). As a result, there will be times when thread 1 (204) will become the privileged thread (202) and other times when thread n (206) will become the privileged thread.

In one or more embodiments of the invention, a single state variable and next state logic is used for all participating threads in the hot-plug device. In order to allow each thread to execute, state-sharing is employed. In state sharing, each thread corresponds to a set of states it has ownership over. A state that is completely owned by one thread is called a control state (208, 210, 212), and a state that is shared amongst threads is called an ownership transfer state (214). A thread is not allowed to execute if it does not have ownership of a state, and an ownership transfer state allows one thread to relinquish control of the finite state machine and another to take over the finite state machine and execute a set of control instructions. In one or more embodiments of the invention, control states (208, 210, 212) correspond to periods where a thread is accessing a critical section, or shared resource. Because no other threads can claim ownership of a control state other than the one it is assigned to, access of shared resources is restricted to the privileged thread and thus mutual exclusion of critical sections is implemented.

In one or more embodiments of the invention, hot-plug threads (privileged thread (202), thread 1 (204), thread n (206)) will sleep and wake at fixed periods. When a thread is awake and can claim ownership of the current state, it will execute a control operation related to the hot-plug event until its next scheduled sleep period. Once a control operation is completed by the thread, it will cycle the finite state machine to another state, until eventually an ownership transfer state (214) is reached. This allows another thread to take ownership of the finite state machine and cycle to new states that are owned by it.

For example, if the current state corresponded to a control state of the privileged thread (208), the privileged thread (202) could execute a set of instructions and transition to another state (220) before going to sleep. During this time, any other thread (thread 1 (204), thread n (206)) entering its wake period would check the current state and discover that it does not have ownership of that state. Those threads (thread 1 (204), thread n (206)) would then go back to sleep and wake up after the sleep period to check again. Once the privileged thread (202) wakes and completes operations, it may cycle to an ownership transfer state (218) and go to sleep. Other threads (thread 1 (204), thread n (206)) may then wake and assume control of the finite state machine. If thread 1 (204) were to wake first, it would cycle the finite state machine to a control state (210) it owned and execute its own set of instructions before transitioning to an ownership transfer state (214), alternating between sleep and wake periods as it does. If thread n (206) were to wake first, it would also begin its own sequence, cycling to a control state (212) it had ownership of, alternating periods of executing instructions and sleeping, until it transitioned to another ownership transfer state (214).

In one or more embodiments of the invention, a privileged thread (202) that cycles to an ownership transfer state (214) may employ a watchdog clock (not shown) that will allow it to regain control of the finite state machine if a new thread (thread 1 (204), thread n (206)) never responds. Furthermore, in one or more embodiments of the invention, sleep and wake periods of threads may be changed based on conditions. For example, if the privileged thread (202) is the only one left executing and all other threads (thread 1 (204), thread n (206)) have completed execution and exited the finite state machine, then the sleep period for the privileged thread (202) may be omitted so that it may complete operations more quickly.

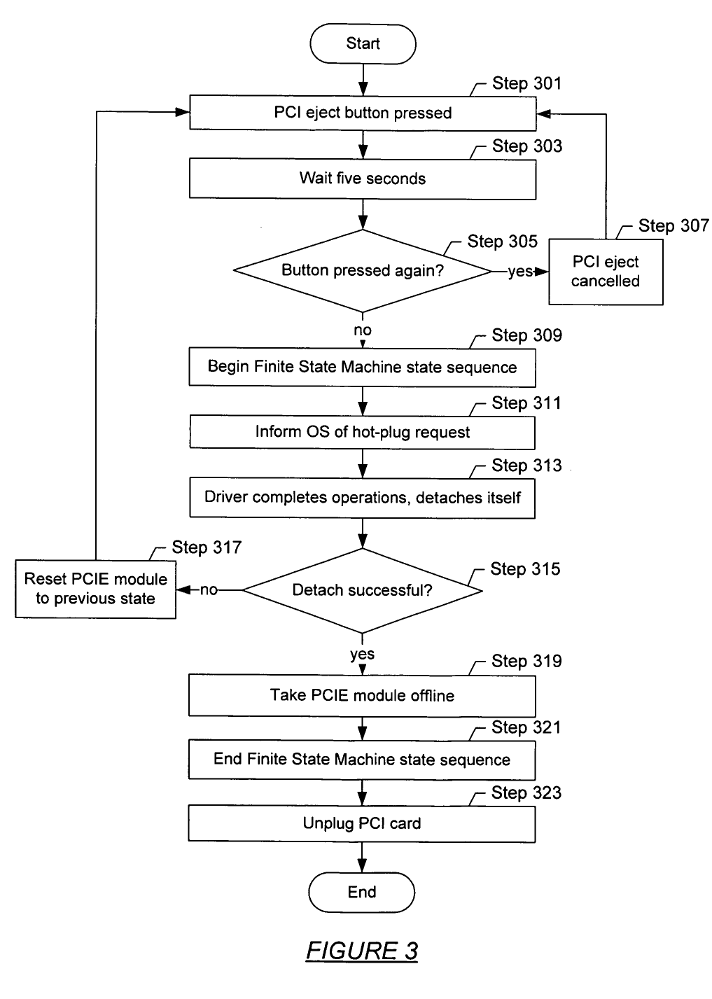

FIG. 3 shows a flow diagram of a hot-plug remove operation in accordance with one or more embodiments of the invention. Specifically, FIG. 3 shows a process for handling a hot-plug removal of a PCI card in accordance with one or more embodiments of the invention.

Initially, a hot-plug event is triggered when a PCI eject button is pressed (Step 301) on a PCI card by a user. The system then waits five seconds (Step 303) to allow the user to cancel the hot-plug event. During this period, the system checks to see if the user presses the button again (Step 305). If so, the user has cancelled the eject operation (Step 307) and the system correspondingly cancels any hot-plug induced changes. Those skilled in the art will appreciate that a hot-plug event may be triggered via other means, such as being invoked within the operating system. In one or more embodiments of the invention, a hot-plug event triggered through the operating system will omit the five second retraction window and the hot-plug operation is immediate.

If the user does not press the button again within the five second window, the system acknowledges that a hot-plug event is to occur and begins a finite state machine state sequence (Step 309). At this time, hot-plug related threads are spawned and enter a finite state machine that regulates their activity. All steps taking place during the finite state machine state sequence are executed by threads that transfer control of the finite state machine between one another, as described above. Furthermore, in one or more embodiments of the invention, hot-plug threads subscribe to fixed sleep and wake periods and only execute instructions when they have ownership of the current state.

Once the finite state machine sequence is started (Step 309), the operating system is informed by one or more hot-plug threads of the hot-plug request (Step 311). In the case where the hot-plug event is invoked through the operating system, this step is omitted, since the operating system already knows of the hot-plug event. Once the operating system is informed of the hot-plug request, it will request the hot-plug device driver to complete operations and detach itself (Step 313). The operating system then checks to see if the detach has been successful (Step 315). If not, the PCIE module is then reset to its previous state (Step 317) and the user must restart the hot-plug process at a later time. For example, if the PCIE module is being used by another resource and cannot be taken offline within a certain period of time, the detach process (Step 313) may be denied and the user notified of the denial. The PCIE module is then allowed to continue and complete operations for the other resource so that at a later time, it can be taken offline.

If the driver detach is successful, the PCIE module is taken offline (Step 319) and brought to a power-down state. At this time, the finite state machine state sequence is completed (Step 321) and the user may unplug the PCI card (Step 323).

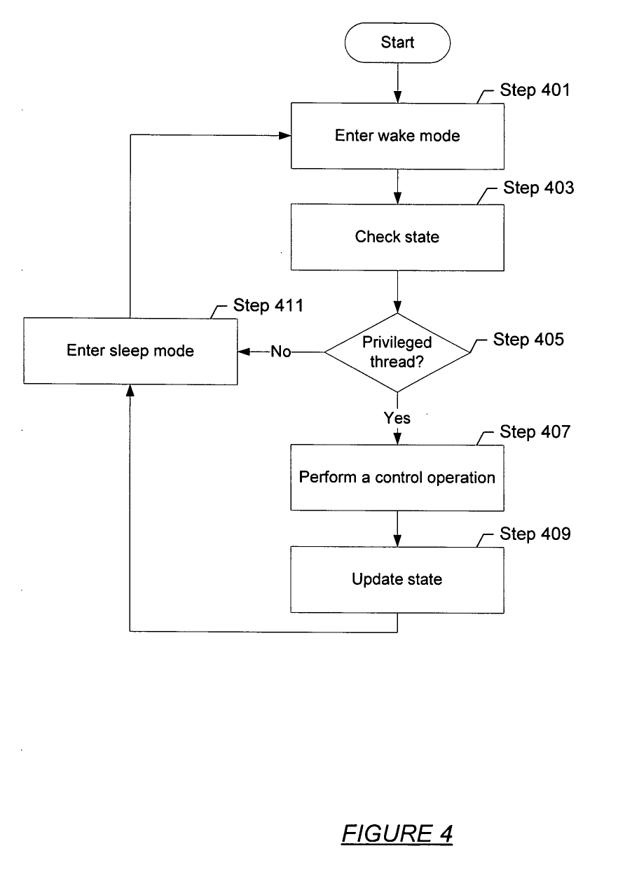

FIG. 4 shows a flow diagram of a thread operating within a finite state machine in accordance with one or more embodiments of the invention. As stated above, in one or more embodiments of the invention, each hot-plug thread is timed to sleep and wake over set periods. Threads are inactive when asleep and can only execute instructions when awake. Those skilled in the art will appreciate that sleep and wake periods of threads do not need to be related for the invention to work.

First, a thread must enter its wake mode (Step 401). Once it is awake, it checks the current state of the finite state machine (Step 403). As stated above, in one or more embodiments of the invention, a single state variable and next state logic is maintained for all participating threads for a given hot-plug device. Once the thread has identified the current state, it executes the next state code, which is the same for all threads. Different actions are taken based on whether the thread is the privileged thread or not (Step 405). If the thread is not the privileged tread, then it goes back to sleep (Step 411) and wakes up after its sleep cycle to check the state again. When the current state is a control state of a particular thread, only that thread is allowed to execute hot-plug related instructions. All other threads will wake up, check the current state, go back to sleep and repeat until the current state has been transitioned to an ownership transfer state, which will allow another thread to take control.

If the thread is the privileged thread, it may perform a control operation (Step 407) related to the hot-plug event. For example, the thread may perform clean-up operations between the hot-plug device and operating system, or it may be powering down or powering up the hot-plug device. Once the thread has performed its control operation (Step 407), it updates the state (Step 409) in the finite state machine. The state may be updated to another control state of the thread, or it may be updated to an ownership transfer state, which would allow other threads to take over the finite state machine. Once the state is updated, the thread enters a sleep cycle (Step 411) and relinquishes control of the finite state machine.

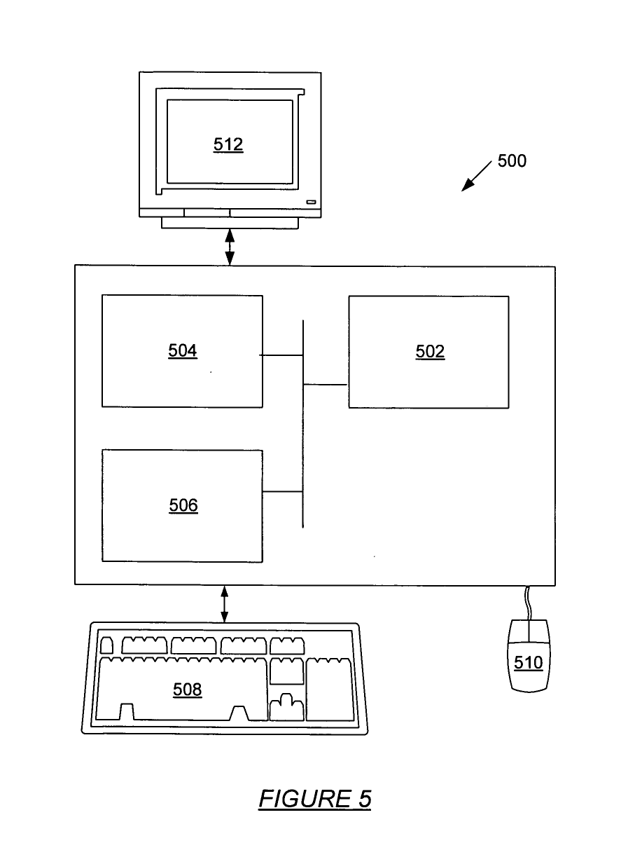

The invention may be implemented on virtually any type of computer regardless of the platform being used. For example, as shown in FIG. 5, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g. finite state machine, hot-plug device, operating system, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for controlling hot-plug behavior comprising:
identifying a hot-plug event caused by a hot-plug device;
generating hot-plug threads that execute a hot-plug operation;
executing a finite state machine state sequence to regulate hot-plug threads involved in the hot-plug operation; and
completing the hot-plug operation at the end of the finite state machine state sequence.

2. The method of claim 1, further comprising executing hot-plug thread instructions over sleep and wake periods.

3. The method of claim 1, further comprising implementing a finite state machine using ACPI.

4. The method of claim 1, wherein the hot-plug device is a PCI module.

5. The method of claim 2, further comprising employing state sharing, which comprises:
a plurality of control states, wherein one thread has complete ownership of a control state; and
a plurality of ownership transfer states, wherein a plurality of threads have ownership of an ownership transfer state.

6. The method of claim 5, further comprising:
a wake mode of a thread, wherein the thread checks for ownership of a current state of the finite state machine state sequence; and
a sleep mode of a thread, wherein the thread is inactive.

7. The method of claim 6, the wake mode further comprising:
a non-ownership of the current state of the finite state machine state sequence by a thread, wherein the thread relinquishes control of the finite state machine; and
an ownership of the current state of the finite state machine state sequence by a thread, comprising:
performing of a control operation by the thread; and
updating of the current state.

8. The method of claim 1, the hot-plug operation further comprising:
notifying an OS of a hot-plug request;
informing a driver by the OS to complete operations; and
detaching the driver when operations are complete.

9. The method of claim 1, wherein timeout conditions cause the hot-plug operation to return to a well-known state.

10. A computer usable medium having computer readable program code embodied therein for causing a computer system to execute a method for controlling hot-plug behavior comprising:
identifying a hot-plug event caused by a hot-plug device;
generating hot-plug threads that execute a hot-plug operation;
executing a finite state machine state sequence to regulate hot-plug threads involved in the hot-plug operation; and
completing the hot-plug operation at the end of the finite state machine state sequence.

11. The computer usable medium of claim 10, the method executing hot-plug thread instructions over sleep and wake periods.

12. The computer usable medium of claim 11, the method employing state sharing, which comprises:
a plurality of control states, wherein one thread has complete ownership of a control state; and
a plurality of ownership transfer states, wherein a plurality of threads has ownership of an ownership transfer state.

13. The computer usable medium of claim 11, the method further comprising:
a wake mode of a thread, wherein the thread checks for ownership of a current state of the finite state machine state sequence; and
a sleep mode of a thread, wherein the thread is inactive.

14. The computer usable medium of claim 13, the wake mode further comprising:
a non-ownership of the current state of the finite state machine state sequence by a thread, wherein the thread relinquishes control of the finite state machine; and
an ownership of the current state of the finite state machine state sequence by a thread, comprising:
performing of a control operation by the thread; and
updating of the current state.

15. A hot-plug control system for a computer system comprising:
a hot-plug device;
a set of hot-plug threads that regulate operations in the hot-plug device; and
a finite state machine that controls execution of instructions using the set of threads.

16. The hot-plug control system of 15, further comprising a fault injection mechanism to validate the control logic of the finite state machine.

17. The hot-plug control system of 15, implementing tracing of execution flow of the hot-plug threads.

18. The hot-plug control system of 15, wherein the hot-plug device comprises a PCI module.

19. The hot-plug control system of 15, wherein the hot-plug system is multithreaded.

20. The hot-plug control system of 15 wherein the finite state machine is implemented using ACPI.
